(19) United States
(12) Patent Application Publication
(10) Pub. No.: US 2026/0010356 A1
(43) Pub. Date: Jan. 8, 2026

(54) SYSTEM AND METHOD FOR BUILDING AND DEPLOYING MULTI-PLATFORM SUPPORT APPLICATION

(71) Applicant: INSWAVE SYSTEMS CO., LTD., Seoul (KR)

(72) Inventors: Se Yong EO, Seoul (KR); Woog Lae KIM, Seoul (KR)

(21) Appl. No.: 19/102,685

(22) PCT Filed: Jul. 31, 2023
(86) PCT No.: PCT/KR2023/011115

§ 371 Date: Jun. 9, 2025

(30) Foreign Application Priority Data
Aug. 9, 2022 (KR) 10-2022-0099409

(51) Int. Cl. G06F 8/60; G06F 8/41; G06F 8/71; G06F 9/445; G06F 16/955

(52) U.S. Cl. CPC G06F 8/60; G06F 8/41; G06F 8/71; G06F 9/44526; G06F 16/9554

(57) ABSTRACT

A system and a method for building and deploying a multi-platform support application are disclosed. The system for building and deploying a multi-platform support application, according to one embodiment of the present invention, comprises: an application content creation unit for creating application content in the form of a web application through a web developer terminal; a native plugin selection unit for selecting a native plugin to be applied to the application content; a building unit, which applies, by platform, in conjunction with a version management server, the native plugin selected by means of the native plugin selection unit to the application content, so as to automatically build same; and a deploy unit for primarily deploying the built application through an internal deploy server or secondarily deploying same through a store.

### FIELD OF THE INVENTION

The present invention relates to system and method for building and deploying multi-platform support application.

### BACKGROUND

Digital transformation has been in the spotlight recently. Digital transformation means that our lives and business works are being converted to digital using new digital technologies.

Companies/organizations are changing to using the cloud to provide services without having to configure their own servers or operating environments. Using a cloud service means that data or resources exist on an external cloud.

This is bringing about a change to a new work environment of diverse collaboration and sharing through mobile devices such as smartphones, and the need for work programs capable of supporting collaboration and sharing is rapidly increasing to adapt to this.

Currently, the market is divided into platforms for mobile app development and desktop application platforms. In the mobile ecosystem, with the emergence of incompatible mobile operating systems such as Apple's iOS and Google's Android, the burden of developing separate applications for specific operating systems has increased, and hybrid apps, which can efficiently and easily create a single app that can run on multiple platforms such as IOS, Android, and Windows with a single development effort, have begun to attract attention.

Korean Patent Publication No. 10-2013-0017337 discloses a hybrid app development platform architecture and test method of the same, and computer-readable recording medium with program for the same.

### SUMMARY

### Technical Objectives

The present invention is intended to provide a system and method for building and deploying a multi-platform support application that can automatically generate and deploy an application (also called an app) that supports multiple platforms by providing platform-specific native functions in the form of built-in plugins and using web standard technology.

The present invention provides system and method for building and deploying a multi-platform support application that supports both iOS and Android environments and can minimize the number of native developers involved.

Other objectives of the present invention will be readily understood through the following description.

### Technical Solutions

According to one aspect of the present invention, there is provided a system for building and deploying multi-platform support application, including an app content creation unit configured for creating app content in the form of a web app through a web developer terminal, a native plugin selection unit configured for selecting a native plugin to be applied to the app content, a build unit, in connection with a version control server, configured for applying the native plugin selected by the native plugin selection unit to the app content for each platform to cause an automatic build, and a deploy unit configured for deploying the built app firstly through an internal deploy server or secondarily through a store.

The build unit may be configured performing the following steps: performing a project plugin duplication check, loading a plugin meta data, adding a plugin dependency information to a project, adding the plugin meta data to the project, copying a plugin js file to the project, applying a library and framework file to the project, and copying a resource.

The deploy unit may be configured for providing a downloadable link for the built app in the form of a QR code during the first deploy.

The deploy unit may be configured for performing the second deploy through App Store of iOS and Play Store of Android upon approval of a web developer based on the first deploy.

The build unit may be configured for selecting and designating a remote mode or an offline mode for storing web resources in a multi-platform environment.

According to another aspect of the present invention, there is provided a system for building and deploying multi-platform support application, including a web browser running on a web developer terminal, a manager server configured for communicating with the web browser, providing a UI for an interface with a user, and transmitting a user command, and a builder configured for communicating with a version control server (VCS), an app file server, and a store, and automatically builds a web app by applying a platform-specific native plugin according to the user command.

The web browser may be configured for providing a screen for performing settings regarding the builder, the version control server, the app file server, and the certificate, and receiving each setting value from a web developer.

The manager server may start with HTTP servlet controller communication, processes parameter information within the HTTP servlet controller to generate a first websocket message and transmits it to the builder. The builder may receive the first websocket message and transmits the parameter to a websocket builder handler, so that an internal process operates in the build handler. When the operation is completed, the builder may transmit a second websocket message to the manager server.

The system may performs a method for creating, setting and loading a project, including processing, by the manager server, a parameter required for project creation and transmitting to the builder, performing, by the builder, a project creation based on parameter value received from the manager server, performing a VCS checkout/clone command when a project is created, performing an app config setting CLI when the VCS checkout/clone is complete, performing a certificate setting, performing an app icon setting, performing a VCS commit/push, transmitting a project creation completion processing parameter value to the manager server, and updating, by the manager server, DB using the project creation completion processing parameter value.

The system may perform a method for build communication, including processing, by the manager server, a parameter required for build and transmitting to the builder, performing, by the builder, a build based on parameter value received from the manager server, performing a VCS update/pull command when the build is performed, performing an app config search CLI when the VCS update/pull is complete, performing a build CLI, performing an app file upload, performing an app config setting, performing a VCS commit/push, transmitting a build completion processing parameter value to the manager server, and updating, by the manager server, DB using the build completion processing parameter value.

The system may perform a method for deploying, including processing, by the manager server, a parameter required for deploy and transmitting to the builder, starting, by the builder, deploy according to parameter value transmitted from the manager server, performing a deploy command when performing deploy, transmitting an app file and an app config information to a platform-specific store when a deploy CLI is started, when outputting a deploy status log data, transmitting a deploy success or failure value transmitted from the platform-specific store to the manager server, and updating, by the manager server, DB using a deploy completion processing parameter value.

Other aspects, features and advantages other than those described above will become apparent from the following drawings, claims and detailed description of the invention.

### Effects of Invention

According to embodiments of the present invention, it is advantageous to automatically build and deploy multi-platform support applications (also referred to as app) by providing platform-specific native functions in the form of built-in plugins and using web standard technologies.

Furthermore, it supports both iOS and Android environments and minimizes the need for native developers.

### BRIEF DESCRIPTION OF ACCOMPANYING DRAWINGS

FIG. 1 exemplarily illustrates a system for building and deploying multi-platform support application according to one embodiment of the present invention;

FIG. 2 is a flowchart of a method for building multi-platform support application multi-platform support application according to one embodiment of the present invention;

FIG. 3 is a flowchart of a method for deploying multi-platform support application multi-platform support application according to one embodiment of the present invention;

FIG. 4 exemplarily illustrates a web development process;

FIG. 5 exemplarily illustrates a built-in native plugin build process;

FIG. 6 exemplarily illustrates an offline mode support function capable of responding to mobile-specific network failure;

FIG. 7, FIG. 8 and FIG. 9 are tables regarding basic native plugins;

FIG. 10 is a table showing third-party linked plugins;

FIG. 11 exemplarily illustrates a plugin application process;

FIG. 12 exemplarily illustrates a build process;

FIG. 13 exemplarily illustrates system for building and deploying multi-platform support application according to one embodiment of the present invention;

FIG. 14 is a flow chart of a project creating method (VCS sync) according to one embodiment of the present invention;

FIG. 15 is a flow chart of a build method according to one embodiment of the present invention;

FIG. 16 is a flowchart of a deploy method according to one embodiment of the present invention;

FIG. 17 exemplarily illustrates a build and deploy scenario through project creation; and

FIG. 18 exemplarily illustrates a build and deploy scenario when a project exists.

### DETAILED DESCRIPTION

The invention can be modified in various forms and specific embodiments will be described below and illustrated with accompanying drawings. However, the embodiments are not intended to limit the invention, but it should be understood that the invention includes all modifications, equivalents, and replacements belonging to the concept and the technical scope of the invention.

If it is mentioned that an element is “connected to” or “coupled to” another element, it should be understood that still another element may be interposed therebetween, as well as that the element may be connected or coupled directly to another element. On the contrary, if it is mentioned that an element is “connected directly to” or “coupled directly to” another element, it should be understood that still another element is not interposed therebetween.

Terms such as first, second, etc., may be used to refer to various elements, but, these element should not be limited due to these terms. These terms will be used to distinguish one element from another element.

The terms used in the following description are intended to merely describe specific embodiments, but not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

Elements of an embodiment described below with reference to the accompanying drawings are not limited to the corresponding embodiment, may be included in another embodiment without departing from the technical spirit of the invention. Although particular description is not made, plural embodiments may be embodied as one embodiment.

In describing the invention with reference to the accompanying drawings, like elements are referenced by like reference numerals or signs regardless of the drawing numbers and description thereof is not repeated. If it is determined that detailed description of known techniques involved in the invention makes the gist of the invention obscure, the detailed description thereof will not be made.

Terms such as ˜part, ˜unit, ˜module mean an element configured for performing a function or an operation. This can be implemented in hardware, software or combination thereof.

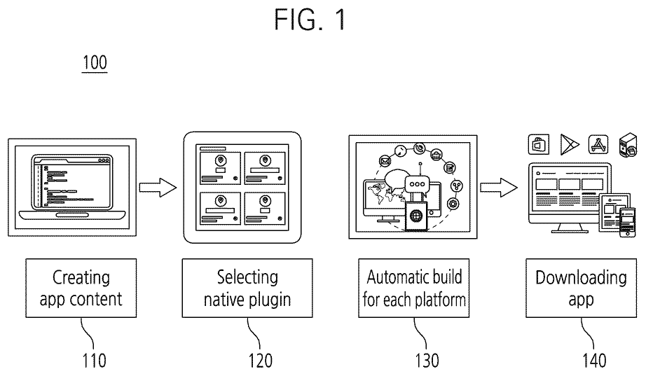

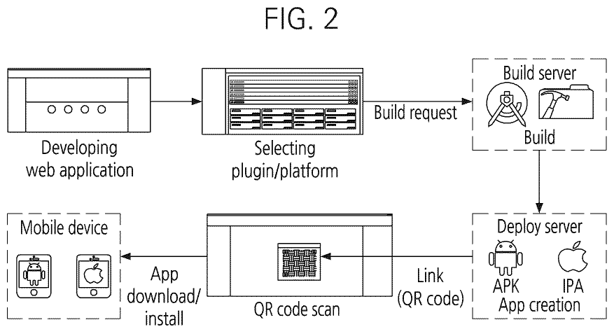

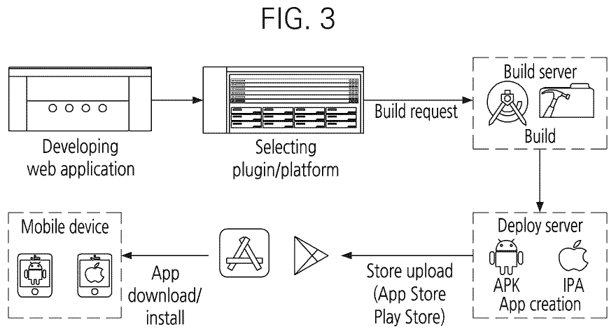

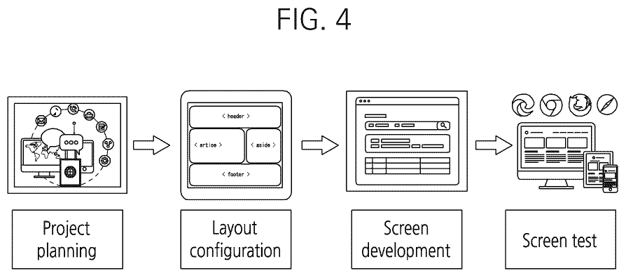

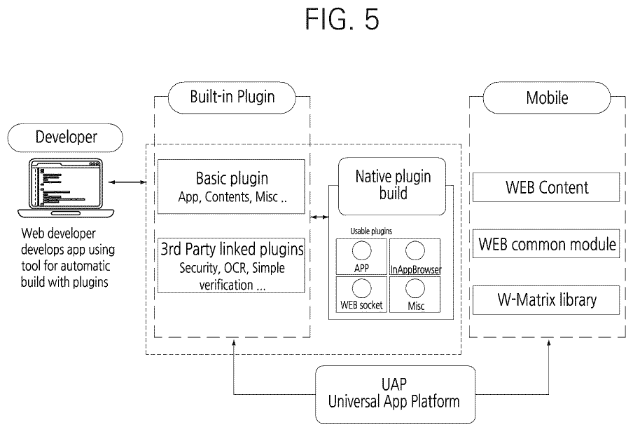

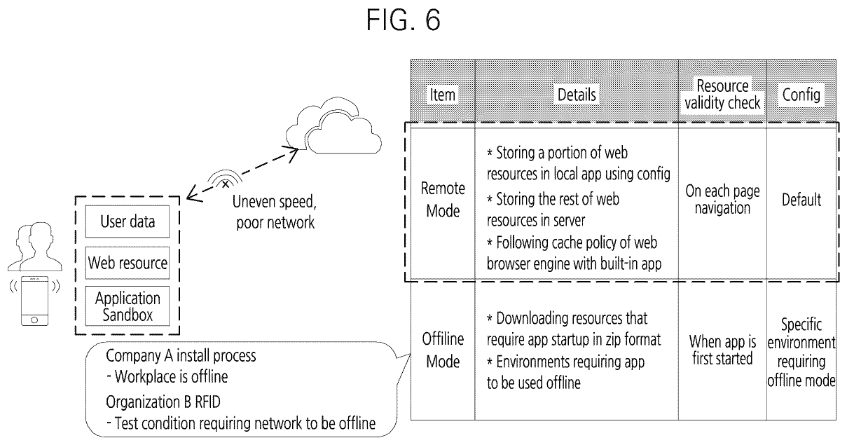

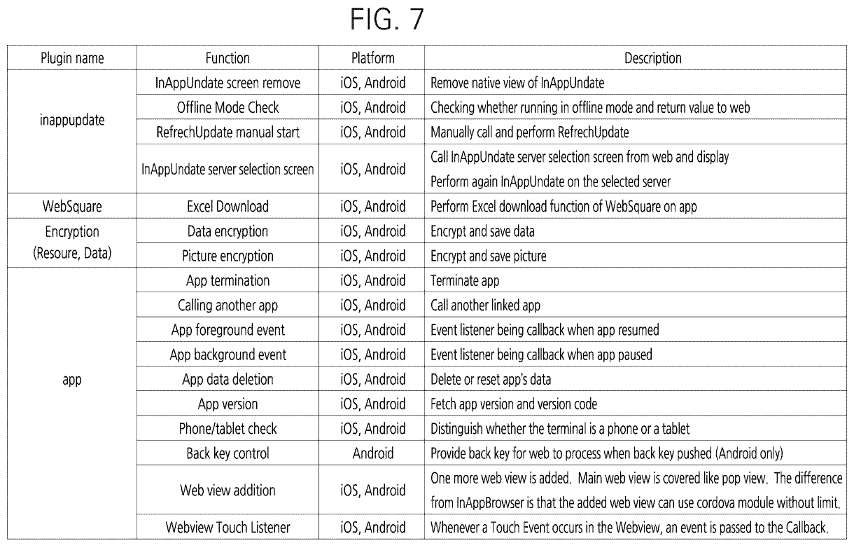

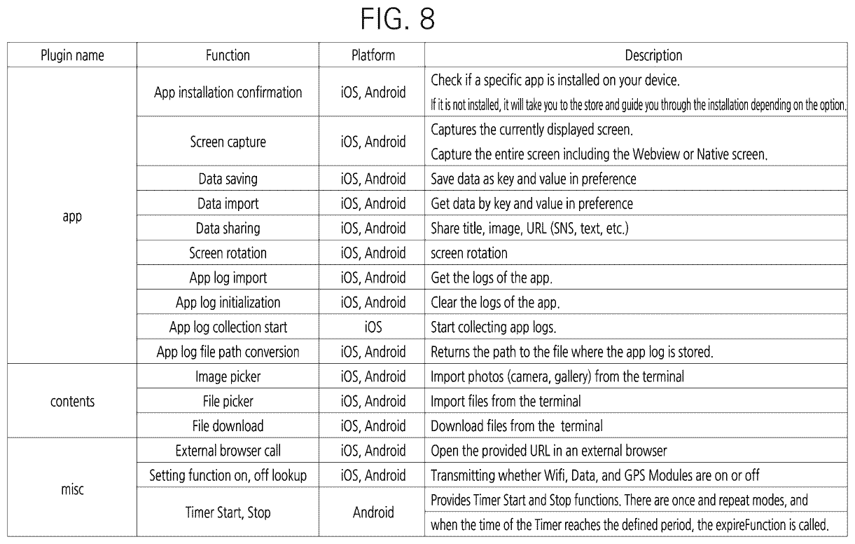

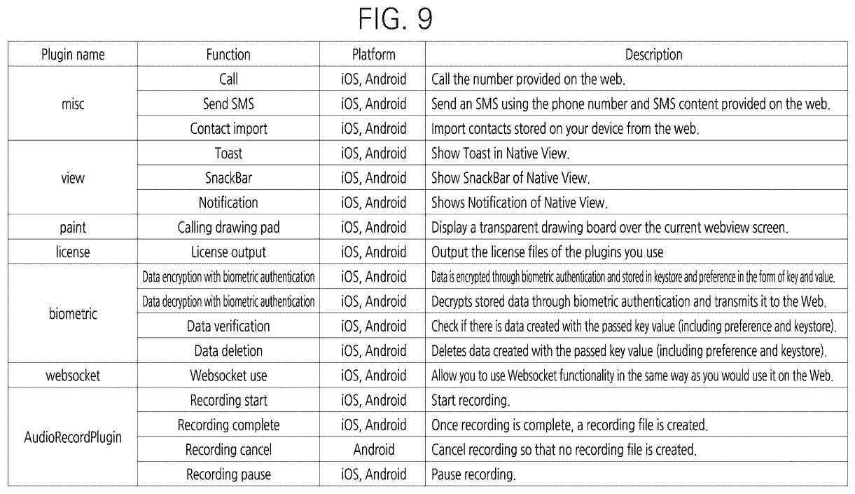

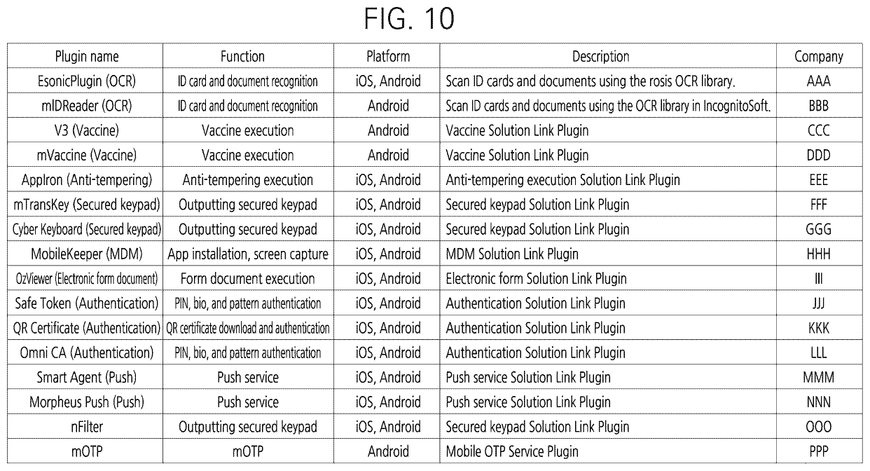

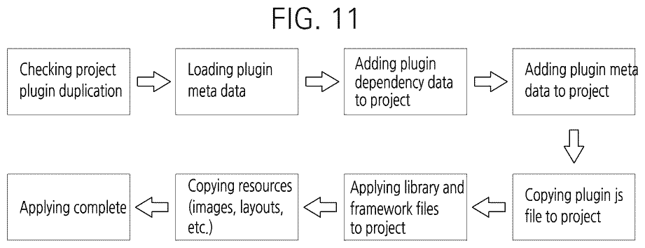

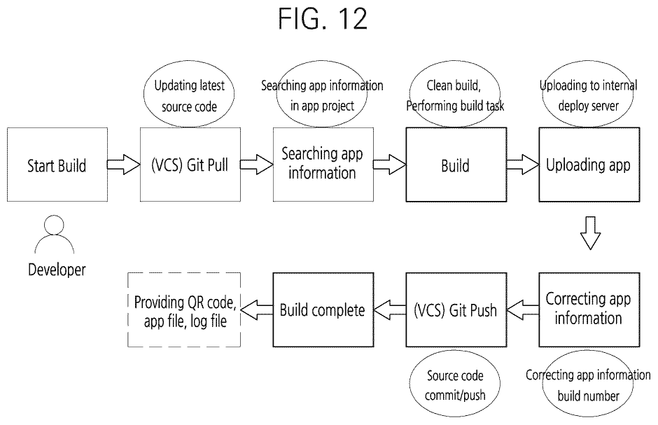

FIG. 1 exemplarily illustrates a system for building and deploying multi-platform support application according to one embodiment of the present invention, FIG. 2 is a flowchart of a method for building multi-platform support application multi-platform support application according to one embodiment of the present invention, FIG. 3 is a flowchart of a method for deploying multi-platform support application multi-platform support application according to one embodiment of the present invention, FIG. 4 exemplarily illustrates a web development process, FIG. 5 exemplarily illustrates a built-in native plugin build process, FIG. 6 exemplarily illustrates an offline mode support function capable of responding to mobile-specific network failure, FIGS. 7 to 9 are tables regarding basic native plugins, FIG. 10 is a table showing third-party linked plugins, FIG. 11 exemplarily illustrates a plugin application process, and FIG. 12 exemplarily illustrates a build process.

The system for building and deploying multi-platform support application 100 according to one embodiment of the present invention functions as a Universal App Platform for digital transformation.

It enables the development of cross-platform applications that inherit the advantages of hybrid apps. Native functions are implemented with web standard technologies, and multi-platforms can be supported.

It also provides a plugin API for platform-specific native integrations, and native plugins for various third-party integrations may be possible.

For operations and maintenance, it can provide app management, deployment, notifications, error/performance monitoring, statistics/charts, collaboration management, big data analysis/prediction, and mass deployment capabilities.

In addition, as an app build/deploy system that supports both iOS and Android environments, the need for native developers can be minimized.

The system for building and deploying multi-platform support application 100 may provide platform-specific native functions in the form of built-in plugins, and may build and deploy apps that support multi-platforms using web standard technologies (JavaScript, HTML, CSS, etc.).

Referring to FIG. 1, the system for building and deploying multi-platform support application 100 may include an app content creation unit 110, a native plugin selection unit 120, a build unit 130, and a deploy unit 140.

The system for building and deploying multi-platform support application 100 enables web developers to build Android and iOS apps through the build unit 130 even without building a separate app build environment. Even without native developers, the system 100 may enable web developers to develop/build/deploy/operate apps including native functions through plugins provided by the system.

The app content creation unit 110 may be configured for enabling developers (web developers) to create an app content that they want to provide in the form of web apps. Various web app development tools that enable web app development can be applied to the app content creation unit 110.

Referring to FIG. 4, in a web app development process, a project planning stage, a layout configuration stage, a screen development stage, and a screen test stage may be sequentially performed so that a web standard application can be developed.

In the project planning stage, a project for the application to be developed, built, and deployed may be configured.

In the layout configuration stage, various layouts for the application through a layout wizard or layout template may be configured.

In the screen development stage, the application screen may be developed using functions such as page templates, component wizards, design systems, and user-defined components. In addition, in one embodiment, a native plugin component may be provided so that it can function as a multi-platform support app.

In the screen test stage, OSMU (One Source Multi Use) test may be performed so that an optimal screen can be displayed on various screen sizes such as PCs, tablets, and smartphones.

Referring back to FIG. 1, the native plugin selection unit 120 may be configured for selecting a native plugin to be additionally applied to the app content created by the app content creation unit 110 according to user (developer) input.

Web developers can control native plugins through web common modules using standard JS. Native plugin is a built-in plugin, and may include basic plugins and third-party linked plugins.

The basic plugins may include, as shown in FIGS. 7 to 9, an inappupdate plugin's functions such as in-app update screen removal, offline mode check, manual start of refresh update, and in-app update server selection screen; a WebSquare plugin's Excel download function; an encryption plugin's functions such as data encryption and photo encryption, the app plugin's functions such as app termination, calling another app, app foreground event, app background event, app data deletion, app version, phone/tablet check, back key control, web view addition, web view touch listener, app installation confirmation, screen capture, data saving, data import, data sharing, screen rotation, app log import, app log initialization, app log collection start, and app log file path conversion; a contents plugin's functions such as image picker, file picker, and file download; a mics plugin's functions such as external browser call, setting function on, off lookup, timer start, stop, call, send SMS, and contact import; a view plugin's functions such as toast, snackbar, and notification; a paint plugin's calling drawing pad function, the license plugin's license call function; a license plugin's license output function; a biometric plugin's functions such as the data encryption with biometric authentication, the data decryption with biometric authentication, data verification, and data deletion; a websocket plugin's websocket use function; and an AudioRecorderPlugin plugin's functions such as the recording start, recording complete, recording cancel, and recording pause.

The third-party linked plugins may include, as shown in FIG. 10, ElectronicPlugin and mIDReader plugins for ID card and document recognition functions, V3 and mVaccine plugins for vaccine execution functions, AppIron plugin for anti-tamper execution functions, mTransKey and Cyber Keyboard plugins for secured keypad output functions, MobileKeeper plugin for app installation, screen capture, and other functions, OzViewer plugin for form document execution function, SafeToken plugin for PIN, bio, and pattern authentication, QR Certificate plugin for QR certificate download and authentication, Omni CA plugin for PIN, bio, and pattern authentication, Smart Agent and Morpheus Push plugins for Push service, nFilter plugin for secure keypad output, and mOTP plugin for mOTP function.

Referring back to FIG. 1, the build unit 130 may be configured for applying the native plugin selected by the native plugin selection unit 120 to the app content created by the app content creation unit 110 for each platform according to a build request after the native plugin selection in the native plugin selection unit 120, thereby automatically building for each platform.

If a web screen is created in the app content, the process of applying plugin is as follows.

The plugin selected by the native plugin selection unit 120 may be additionally applied. In this case, a plugin's version to be applied may be selected. When applying the plugin, separate CLI (Command Line Interface) tools for each platform may be applied. In the case of Android, it can be automatically performed through gradle, and in the case of iOS, it can be automatically performed through a command tool.

The selected plugin can be removed in addition to being added. It can be removed by selecting the plugin to be removed from the list of applied plugins. There is no needed to select version of plugin to be removed, and the applied version can be automatically selected and removed.

Referring to FIG. 11, the build unit 130 may be configured for performing a project plugin duplication check for the plugin selected by the native plugin selection unit 120. Then, it loads a plugin meta data. Plugin dependency data and add plugin meta data may be added to the project. Plugin js file may be copied to the project, and Library and Framework files may be applied to the project. Then, it can complete applying of the plugin by copying the resources (images, layouts, etc.). After applying the plugin settings, the build unit 130 proceeds with the project build.

The detailed build process is as follows (see FIG. 12).

When the build starts, the latest source code is updated through (VCS) Git Pull. Then, app information is searched within the app project. After searching, a build task is performed and the app is uploaded to an internal deploy server. The build is complete through modifying app information (build number), committing and pushing the source code through (VCS) Git Push. When the build is complete, QR code, app file, and log file functions can be provided.

Referring back to FIG. 1, the deploy unit 140 may be configured for deploying the app built by the build unit 130 to the developer through the internal deploy server in a downloadable form (APK, IPA, etc.) for the first time (internal deploy). If the developer approves, the app is registered in the platform-specific store and deployed for the second time (store deploy) so that any users can download, install, and run the app.

Referring to FIG. 2, during the first deploy (internal deploy), a downloadable link may be displayed on the screen of the developer terminal. The downloadable link may be displayed in the form of a QR code, for example. Accordingly, the developer can scan the QR code displayed on the terminal screen using a camera of a mobile device (e.g., a smartphone), download the currently built app to the mobile device, install it (update the app, if necessary), and check whether it has been properly built (check the applied plugin).

Referring to FIG. 3, in the case of second deploy (store deploy), if there is developer's approval for the app that was confirmed to have been built normally through the first deploy, the app built by the build unit 130 can be uploaded to the platform-specific store (Apple's App Store, Google's Play Store, etc.). The app uploaded to the store can be downloaded and installed by an ordinary users through mobile devices.

In addition, referring to FIG. 6, the build unit 130 may be configured for selecting and designating a method (remote mode or offline mode) for storing web resources in a multi-platform environment of various environments during the app building process. When the user's app is run, the web resources can be fetched locally or remotely.

In the remote mode, some of the web resources can be stored in the local app using a config. Except for the resources stored in the local app, the resources are located on the server. And the cache policy of a web browser engine with built-in app may be followed. The resource validity may be checked on each page navigation.

In a specific environment where the offline mode is required, the offline mode can be set. In offline mode, resources that require app startup can be downloaded in zip format. Offline mode may be applied in environments that require the app to be used offline, and resource validity check can be performed when the app is first started. For example, it may be applied to businesses where the workplace is not networked, or where there are test conditions that require the network to be offline, such as procurement agency RFID.

Hereinafter, the method for building and deploying multi-platform support application performed in the build unit 130 and the deploy unit 140 will be described in more detail.

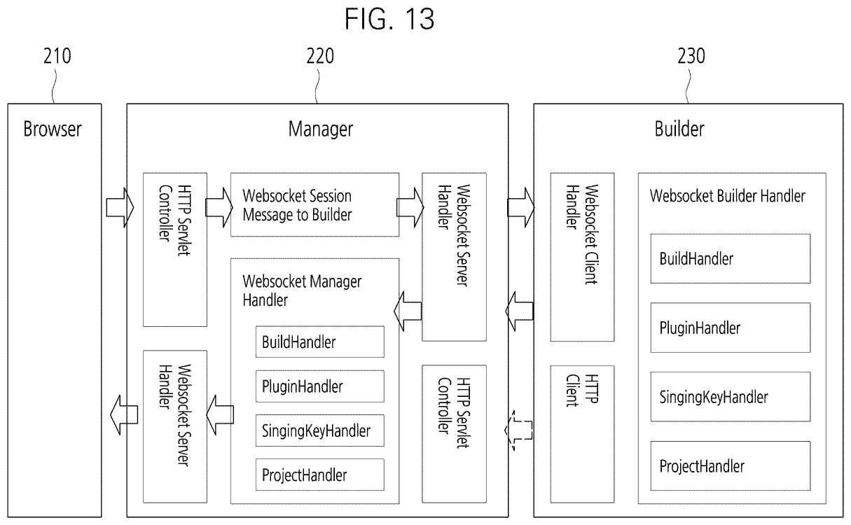

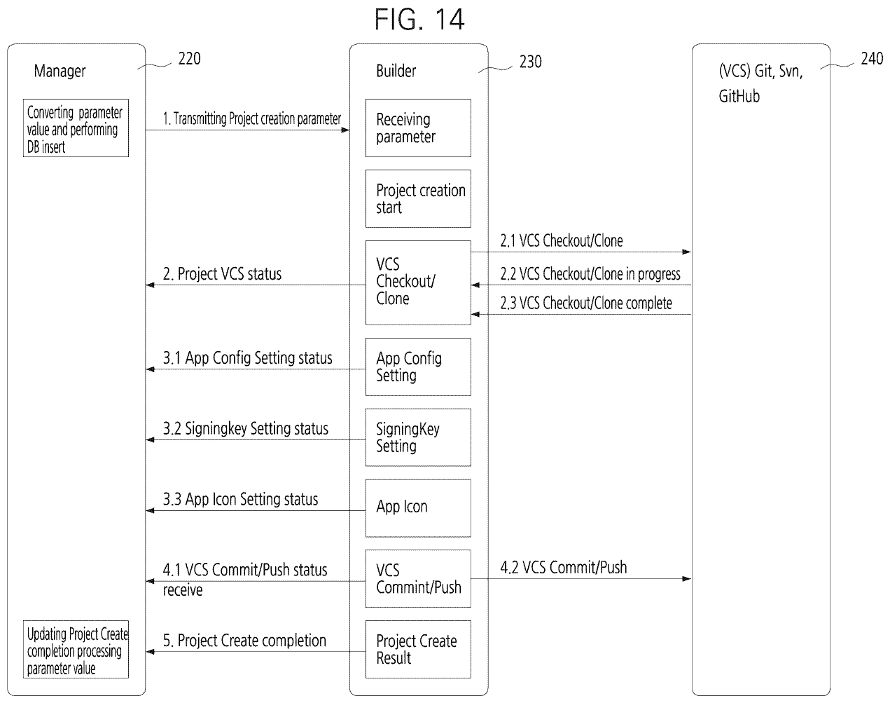

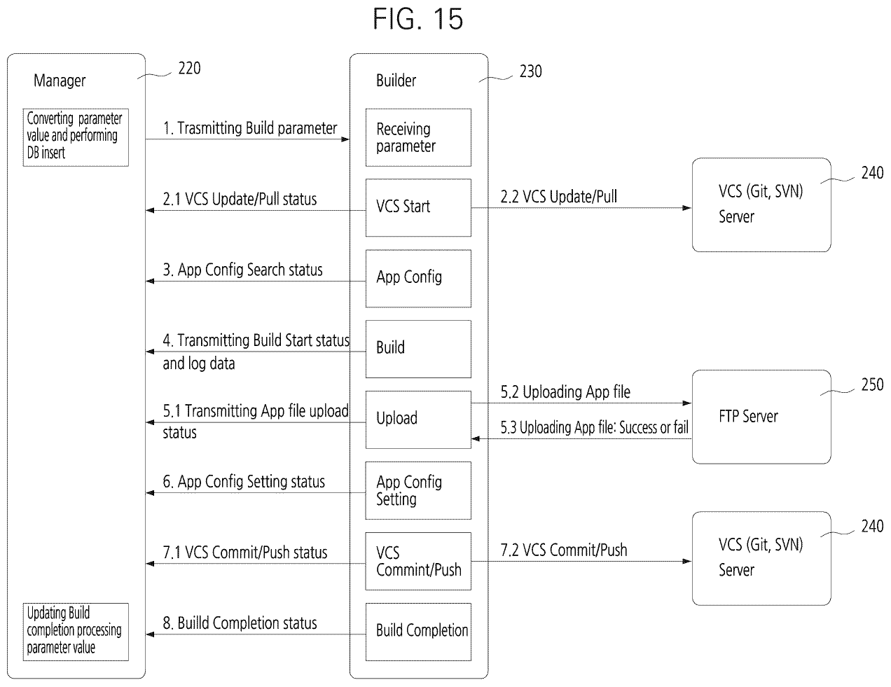

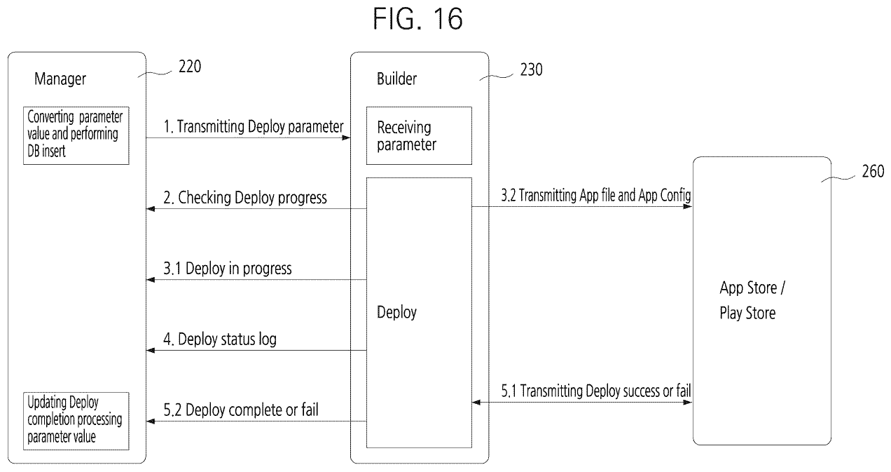

FIG. 13 exemplarily illustrates system for building and deploying multi-platform support application according to one embodiment of the present invention, FIG. 14 is a flow chart of a project creating method (VCS sync) according to one embodiment of the present invention, FIG. 15 is a flow chart of a build method according to one embodiment of the present invention, and FIG. 16 is a flow chart of a deploy method according to one embodiment of the present invention.

The build unit 130 and the deploy unit 140 may be implemented as a program or software that builds and deploys a hybrid app that is made by linking a selected native plugin to the app content.

The build unit 130 may include a manager server 220 and a builder 230.

One or more builders 230 may be connected to one manager server 220.

The manager server 220 is provided through the web and manages and controls the builder 230.

The manager server 220 may provide a UI (user interface) and user data to interface with the user, transmit the user's commands to the builder 230, and perform a role of managing a build information.

The builder 230 is a module that is configured for actually building Android and iOS apps. In addition, the builder 230 may also deploy the built app.

The builder 230 functions as a build server that performs the actual app build. In addition, it performs roles required for app build, such as version control, uploading result, and so on.

In this embodiment, a project may be created based on a template provided by the system. App project VCS (Version Control System) synchronization is also possible. App build, version control, deployment, and plugin management are possible through the web without a native developer. Project addition and modification are possible by linking the source code worked by the developer with the VCS server. Real-time log check and download of the build status are possible. The built app can be installed through a QR code.

The web browser 210 may communicate with the manager server 220 and may be executed on a web developer terminal to provide a screen for users and administrators (web UI).

Settings for projects/builds/deploys can be made through the web browser 210. Settings may include builders, VCS, FTP, certificates, and so on.

Builder information to be connected to the manager server 220 can be created in a builder settings screen. The builder information may include a builder name (entering a name that can be distinguished from a selection list), a builder User ID (entering the same ID as the physically configured builder yaml settings), user permissions (build, deploy (check if necessary)), builder URL (URL information for the builder), and so on.

VCS settings screen may be used when creating Git/SVN/LocalGit property information for a newly created project. VCS information may include a VCS name, a VCS type (selected from Git/SVN/LocalGit), a VCS user ID, a VCS user password, a VCS server URL (VCS access URL), and so on.

TP settings screen may be used to set FTP property information for a new project. FTP information may include a FTP name, a FTP server URL, a FTP server IP, a FTP server port, a FTP user ID, a FTP user password, and so on.

Certificate (Signing Key) settings screen is a screen for creating and saving certificate information and file information required for a new project and build. Since the certificate file formats for Android and iOS are different, the screen configuration may be different for each platform.

Common input values may include a certificate name, a builder ID, a platform, a domain ID, an administrator ID, and so on.

Android certificate input values may include a certificate type (Signingkey Type), a Build Type, a Key Alias, a Key Password, a Store Password, and a certificate file (Signing Key file).

The iOS certificate input values may include a certificate type (Signingkey Type), a Certificate Key file path, a Certificate Key Password, a debug Profile file path, a Release Profile file path, and so on.

The manager server 220 may include an HTTP servlet controller, a Websocket Session Message to Builder, a Websocket Manager Handler, and a Websocket Server Handler.

The builder 230 may include a Websocket Client Handler, a Websocket Builder Handler, and a HTTP Client.

The manager server 220 starts with the HTTP Servlet Controller communication.

The parameter information is processed inside the HTTP Servlet Controller. Then, a message is sent to the Websocket Session Message to Builder.

The builder 230 receives a websocket message from the manager server 220 and transferring the parameters to the Websocket Builder Handler. It moves to Build Handler, and the internal process operates.

When the operation is complete, the builder 230 transfers the websocket message to the manager server 220.

The manager server 220 moves to the build handler with the parameters received from the builder 230, and transfers them to the browser 210 through the Websocket Server Handler.

The flowchart of project creation, setting, and import (VCS Sync) is illustrated in FIG. 14.

The manager server 220 processes parameters required for project creation and transfers them to the builder 230. While transferring, DB Insert function may be performed.

The builder 230 starts the project creation based on the parameter values transferred from the manager server 220.

When creating a project, VCS Checkout/Clone command is performed. At the same time as the execution of the command, the message value is sent from the builder 230 to the manager server 220 via VCS status Websocket.

When the VCS Checkout/Clone task is complete, App Config Setting CLI is performed. Similarly, the message value is sent to the manager server 220 via App Config Setting status Websocket.

When the App Config Setting task is complete, Certificate Setting (SigningKey Setting) task is performed.

When the Certificate Setting task is complete, App Icon Set task is performed. Similarly, the message value is sent to the manager server 220 via App Icon Setting status Websocket.

When the App Icon Set task is complete, VCS Commit/Push task is performed. Similarly, the message value is sent to the manager server 220 via VCS Commit/Push status Websocket.

When the VCS Commit/Push task is complete, Project Create completion processing parameter value is transmitted to the manager server 220.

The manager server 220 processes the DB update using the Project Creation completion processing parameter value received from the builder 230.

The flowchart of build communication is illustrated in FIG. 15.

The manager server 220 processes parameter values required for the build and transmits it to the builder 230. While transferring, DB Insert function may be performed.

The builder 230 starts the build based on the parameter values transferred from the manager server 220.

When the build is performed, VCS Update/Pull command is performed. At the same time as the execution, the message value is sent from the builder 230 to the manager server 220 via the VCS status Websocket.

When the VCS Update/Pull task is complete, App Config Search CLI is performed. Similarly, the message value is sent to the manager server 220 via App Config Query status Websocket.

When the App Config Search task is complete, Build CLI task is performed. Similarly, the message value is sent to the manager server 220 via Build status Websocket.

When the Build CLI task is complete, App File Upload task is performed. Similarly, the message value is sent to the manager server 220 via App File Upload status Websocket.

When the App File Upload task is complete, App Config Setting task is performed. Similarly, the message value is sent to the manager server 220 via App Config Setting status Websocket.

When the App Config Setting task is complete, the VCS Commit/Push task is performed. Similarly, the message value is sent to the manager server 220 via the VCS Commit/Push status websocket.

When the VCS Commit/Push task is complete, Build Completion processing parameter value is transmitted to the manager server 220.

The Build Completion processing parameter value transmitted from the builder 230 to the manager server 220 is received and DB update is performed.

The flowchart of deploy is illustrated in FIG. 16.

The manager server 220 processes the parameters required for Deploy and transmits them to the builder 230. While transferring, DB Insert function may be performed.

The builder 230 starts deploy based on the parameter values transmitted from the manager server 220.

When performing deploy, Deploy command is performed. At the same time as the execution, the builder 230 sends message values to the manager server 220 via Deploy status Websocket.

When Deploy CLI task starts, the app file and app config information are transmitted to App store/Play store.

Deploy status log data is output. The data is immediately transmitted to the manager server 220 as Websocket message value.

When App store/Play store sends Deploy success or failure value, the builder 230 receives the value, and the builder 230 transmits the Websocket message value to the manager server 220.

The Deploy completion processing parameter value transmitted from the builder 230 to the manager server 220 is received and DB update is performed.

Hereinafter, the entire scenario performed in the system for building and deploying multi-platform support application 100 will be described.

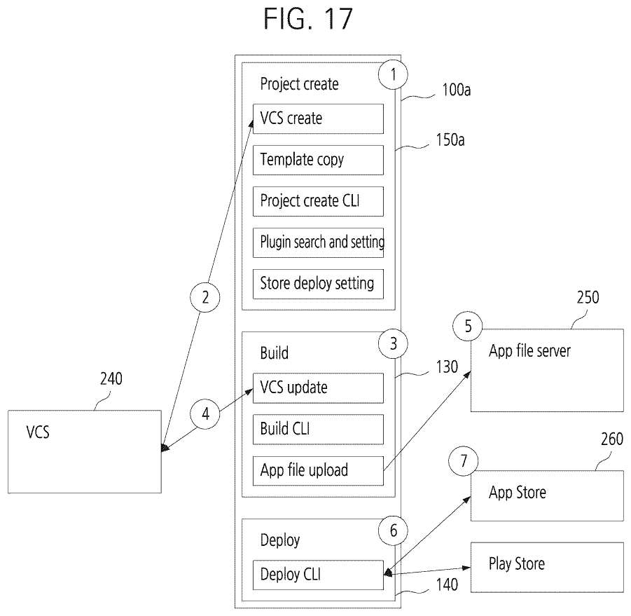

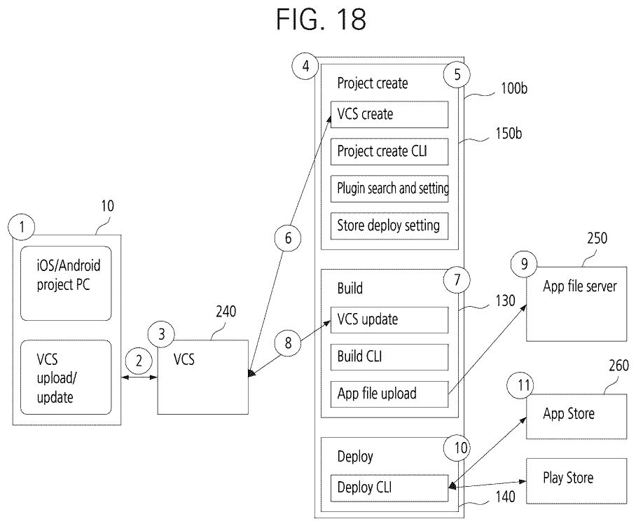

FIG. 17 exemplarily illustrates a build and deploy scenario through project creation, and FIG. 18 exemplarily illustrates a build and deploy scenario when a project exists.

First, referring to FIG. 17, the first system for building and deploying multi-platform support application 100a may include a project creation unit 150a, the build unit 130, and the deploy unit 140.

When creating a project through the screen provided by the project creation unit 150a, basic settings are entered and a profile is selected. Information regarding template version and VCS profile are properly selected according to the VCS settings. When the app information input is complete, a Create button on the screen is clicked.

When the Create button is clicked, the system calls VCS creation command.

When the VCS creation process is complete, proceed to the next step, template copying. When copying is complete, the CLI (commands) required for the next step, project creation, is performed.

When project creation is complete, move to the build screen. When selecting Build Type on that screen and press Build button to perform the build in the build unit 130.

Before the build is performed, a source update (Pull) is performed in VCS. After the update (Pull) is complete, the build is performed.

When the build is complete, an app file is created. The app file is uploaded to an app file server 250. When the app file upload is complete, the entire build process is complete.

If the build is normally complete, move to a detailed list in a build history screen and click a Move button to deploy screen. On the deploy screen, a deploy type (one of beta and deploy) is selected and proceed with the store deploy.

During a deploy process through the deploy unit 140, the app config and app files are transferred to the App Store for iOS and Play Store for Android. Then, Deploy status log is displayed. When the deploy process is complete, the result can be notified to the user.

FIG. 18 illustrates a scenario in the case of an existing project. The second system for building and deploying multi-platform support application 100b may include a project creation unit 150b, the build unit 130, and the deploy unit 140.

A web developer may develop a web app using Xcode and Android Studio through a developer terminal 10. When development is complete, the developer pushes the source to VCS 240, that is, uploads the source code. Therefore, the latest source may be reflected in VCS 240.

When the developer wants to upload the source code or receive an update, a command is called from VCS 240. Upload (Push) is an act of reflecting the source, and update (Pull) is an act of getting the source.

VCS 240 is a server that manages the iOS/Android project source. It is usually Git, SVN.

The system for building and deploying multi-platform support application may be a solution that performs the creation, build, and deploy of iOS/Android projects.

In the process of starting project creation in the project creation unit 150b, the required information and profiles are entered and selected on system screen. The profile can be added in advance on settings screen. Once input of the app information is complete, the project can be created by clicking the Create button.

When Project Create button is clicked, the system calls the VCS creation command. When a cloning process is complete, the CLI (commands) required for project creation are executed.

When the project creation is complete, move to plugin search screen and add the plugin functions required by a user. If there are any unnecessary plugins, they can be removed.

When the plugin is added and the Complete button is clicked, the applying of plugin is performed.

When the applying of plugin is complete, a store deploy setting profile is selected and applied before performing the store deploy.

When the project creation is complete, go to the build screen. Select the build type on the screen and press the Build button to perform the build in the build unit 130.

Before the build is performed, the source update (Pull) is performed in the VCS. After the update is complete, the build can be performed.

When the build is complete, the app file is created. Upload the app file to the app file server 250. When the app file upload is complete, the entire build process is complete.

If the build is normally complete, go to the detailed list in the build history screen and click the Move to Deployment Screen button. On the deploy screen, the deploy type (one of beta and deploy) is selected and proceed with store deploy.

During the deploy process through the deploy unit 140, iOS transfers the app config and app files to the App Store and Android transfers them to the Play Store. Then, Deploy status log is displayed. When the deploy process is complete, the result can be notified to the user.

The above-described method for building and deploying multi-platform support application may also be implemented in the form of a non-transitory recording medium including instructions executable by a computer, such as an application or program module executed by a computer. Non-transitory computer-readable medium can be any available media that can be accessed by a computer and includes both volatile and nonvolatile medium, removable and non-removable media. In addition, non-transitory computer-readable medium may include computer storage medium. Computer storage medium includes both volatile and nonvolatile, removable and non-removable media implemented in any method or technology for storage of information such as computer readable instructions, data structures, program modules or other data.

The above-described method for building and deploying multi-platform support application may be executed by an application (which may include a program included in a platform or operating system by default installed in the terminal) installed by default in the terminal, and by an application (i.e., program) that a user manually installed in the terminal after downloading from an application store server, or an application providing server such as a web server related to the application or service. In this sense, the above-described method for building and deploying multi-platform support application may be implemented as an application (i.e., program) installed by default in the terminal or manually installed by a user, and may be recorded in the non-transitory computer-readable recording medium such as the terminal.

While the invention has been described above with reference to exemplary embodiments, it will be understood by those skilled in the art that the invention can be modified and changed in various forms without departing from the concept and scope of the invention described in the appended claims.

1. A system for building and deploying multi-platform support application, comprising:
an app content creation unit configured for creating app content in the form of a web app through a web developer terminal;
a native plugin selection unit configured for selecting a native plugin provided in the form of a built-in plugin for platform-specific native functions to be applied to the app content;
a build unit, in connection with a version control server, configured for applying the native plugin selected by the native plugin selection unit to the app content for each platform to cause an automatic build; and
a deploy unit configured for deploying the built app firstly through an internal deploy server or secondarily through a store,
wherein the build unit is configured for performing;
performing a project plugin duplication check;
loading a plugin meta data;
adding a plugin dependency information to a project;
adding the plugin meta data to the project;
copying a plugin js file to the project;
applying a library and framework file to the project; and
copying a resource.

2. (canceled)

3. The system for building and deploying multi-platform support application of claim 1, wherein the deploy unit is configured for providing a downloadable link for the built app in the form of a QR code during the first deploy.

4. The system for building and deploying multi-platform support application of claim 1, wherein the deploy unit is configured for performing the second deploy through App Store of iOS and Play Store of Android upon approval of a web developer based on the first deploy.

5. The system for building and deploying multi-platform support application of claim 1, wherein the build unit is configured for selecting and designating a remote mode or an offline mode for storing web resources in a multi-platform environment.

6. A system for building and deploying multi-platform support application, comprising:
a web browser running on a web developer terminal;
a manager server configured for communicating with the web browser, providing a UI for an interface with a user, and transmitting a user command; and
a builder configured for communicating with a version control server (VCS), an app file server, and a store, and automatically builds a web app by applying a platform-specific native plugin plugin provided in the form of a built-in plugin for platform-specific native functions according to the user command,
wherein the build unit completes platform-specific application of the native plugin by performing the steps of performing a project plugin duplication check; loading a plugin meta data; adding a plugin dependency information to a project; adding the plugin meta data to the project; copying a plugin is file to the project; applying a library and framework file to the project; and copying a resource.

7. The system for building and deploying multi-platform support application of claim 6, wherein the web browser is configured for providing a screen for performing settings regarding the builder, the version control server, the app file server, and the certificate, and receiving each setting value from a web developer.

8. The system for building and deploying multi-platform support application of claim 6, wherein the manager server starts with HTTP servlet controller communication, processes parameter information within the HTTP servlet controller to generate a first websocket message and transmits it to the builder,
wherein the builder receives the first websocket message and transmits the parameter to a websocket builder handler, so that an internal process operates in the build handler,
wherein when the operation is completed, the builder transmits a second websocket message to the manager server.

9. The system for building and deploying multi-platform support application of claim 6, wherein the system performs a method for creating, setting and loading a project, comprising:
processing, by the manager server, a parameter required for project creation and transmitting to the builder;
performing, by the builder, a project creation based on parameter value received from the manager server;
performing a VCS checkout/clone command when a project is created;
performing an app config setting CLI when the VCS checkout/clone is complete;
performing a certificate setting;
performing an app icon setting;
performing a VCS commit/push;
transmitting a project creation completion processing parameter value to the manager server; and
updating, by the manager server, DB using the project creation completion processing parameter value.

10. The system for building and deploying multi-platform support application of claim 6, wherein the system performs a method for build communication, comprising:
processing, by the manager server, a parameter required for build and transmitting to the builder;
performing, by the builder, a build based on parameter value received from the manager server;
performing a VCS update/pull command when the build is performed;
performing an app config search CLI when the VCS update/pull is complete;
performing a build CLI;
performing an app file upload;
performing an app config setting;
performing a VCS commit/push;
transmitting a build completion processing parameter value to the manager server; and
updating, by the manager server, DB using the build completion processing parameter value.

11. The system for building and deploying multi-platform support application of claim 6, wherein the system performs a method for deploying, comprising:
processing, by the manager server, a parameter required for deploy and transmitting to the builder;
starting, by the builder, deploy according to parameter value transmitted from the manager server;
performing a deploy command when performing deploy;
transmitting an app file and an app config information to a platform-specific store when a deploy CLI is started;
when outputting a deploy status log data, transmitting a deploy success or failure value transmitted from the platform-specific store to the manager server; and
updating, by the manager server, DB using a deploy completion processing parameter value.
